(19) United States
(12) Patent Application Publication
(10) Pub. No.: US 2020/0042667 A1
(43) Pub. Date: Feb. 6, 2020

(54) Modeling of Power Distribution Networks for Path Finding

(71) Applicants: Madhavan Swaminathan, Atlanta, GA (US); Bill Martin, Dallas, TX (US); KiJin Han, Uslan (KR)

(72) Inventors: Madhavan Swaminathan, Atlanta, GA (US); Bill Martin, Dallas, TX (US); KiJin Han, Uslan (KR)

(73) Assignee: E-System Design, Inc., Savannah, GA (US)

(21) Appl. No.: 16/257,565

(22) Filed: Jan. 25, 2019

Related U.S. Application Data
(63) Continuation-in-part of application No. 15/211,304, filed on Jul. 15, 2016, now abandoned.
(60) Provisional application No. 62/192,649, filed on Jul. 15, 2015.

(51) Int. Cl. G06F 17/50

(52) U.S. Cl. CPC G06F 17/5072; G06F 2217/78

(57) ABSTRACT

In a method producing an electronic circuit includes analyzing pre-register-transfer level phase of a power distribution network in an electronic circuit design. The power distribution network is defined to include a matrix of a number repeated leaf cells, wherein each of the matrix of repeated leaf cells corresponds to a model leaf cell wherein the model leaf cell includes an alternating Vdd and Gnd grid on top of an interposer. A plurality of local ports of the model leaf cell is defined. The plurality of local ports is defined where each of the matrix of repeated leaf cells is coupled to adjacent ones of the matrix of repeated leaf cells. The model leaf cell is simulated using an implementation of an integral equation based solver to compute electromagnetic scattering parameters (S-parameters) that correspond to the model leaf cell. The electromagnetic S-parameters are cascaded across the matrix using a binary merge algorithm. S-parameters of any non-periodic power distribution network component models are coupled to the S-parameters of the matrix. An overall impedance response of the power distribution network is computed based on S-parameters of the matrix and the S-parameters of any non-periodic power distribution network component models using an integrated circuit modelling program. Once the simulated impedance response of the circuit is within the design specification, the design is finalized and the electronic circuit is produced based on the design as finalized.

### CROSS-REFERENCE TO RELATED APPLICATION(S)

This application claims the benefit of U.S. Provisional Patent Application Ser. No. 62/192,649, filed Jul. 15, 2015, the entirety of which is hereby incorporated herein by reference.

This application is a continuation-in-part of, and claims the benefit of, U.S. patent application Ser. No. 15/211,304, filed Jul. 15, 2016, the entirety of which is hereby incorporated herein by reference.

### BACKGROUND OF THE INVENTION

### 1. Field of the Invention

The present invention relates to simulators for electronic circuits and, more specifically, to a system for simulating power distribution networks.

### 2. Description of the Related Art

During the early stage of a digital circuit design process, power distribution networks (PDN) are often created by repeating a circuit pattern several times. The resulting pattern is used as the PDN in a localized area or could cover the entire chip, package or PCB. Examples are power grids, electromagnetic bandgap (EBG) structures and power planes. Due to the physical and electrical size, it is difficult to analyze the entire structure using a full wave electromagnetic (EM) tool due to memory and CPU time limitations.

During the pre-register-transfer level (RTL) phase of a design, a power map of the chip is often used to determine the power supply noise. Using the power map, a distribution of current sources is used to represent the circuit. However, computation of the power supply noise requires the impedances of the PDN. Since the layout is not available, using a repeated grid of the PDN that is then represented using a series of resistors, inductors and capacitors to determine the PDN impedance is used in modelling. The computation of the power supply noise at the pre-RTL phase is a very important exercise since it plays an important role in determining the architectural details of the chip and system.

A user wanting to design a chip needs to determine how much power supply noise is generated between the voltage and ground rails of the transistor circuits. Circuits are non-linear and generate a current. At the early stage of the design process, the designer has an idea of the nature of the current source. For example, they know the amplitude of the current, the rise and fall times as well as the duty cycle. From this information they need to determine the details of the power distribution network such as: i) the width of the metallization on-chip, their periodicity, number of layers, details of the connectivity from the chip pads to the package, the package stack-up such as power/ground planes, details of the solder balls at the bottom of the package etc. At this point the designer needs to compute the power distribution impedance without knowing the exact structure. This impedance along with the current source can be used to determine the power supply noise.

Since at the initial design phase, nothing is known about the power distribution network, the designer often assumes that the network is periodic where a unit cell can be repeated to generate the layout of the chip, package and printed circuit board. However, since most networks are not just repetitions of unit cells, simulation computations of properly described networks can take an extremely long amount of time—especially with large networks. As a result of this, the designer will reduce the size of the structure being analyzed or over-simplify it (or both), which compromises the accuracy of the results of the simulation. Such simulations, then, may incorrectly over-predict or under-predict local power supply noise. This can result in either a noisy circuit or an over-designed circuit, neither of which meet the optimal design specification.

Therefore, there is a need for a power distribution network simulation system that generates a more precise model with minimal computational overhead.

### SUMMARY OF THE INVENTION

The disadvantages of the prior art are overcome by the present invention which, in one aspect, is a method for analyzing pre-register-transfer level phase of a power distribution network in an electronic circuit design, in which a preliminary design for the electronic circuit based on a design specification is generated. Pre-register-transfer level phase of the power distribution network is analyzed by repeating the following steps until simulated impedance response of the circuit is within the design specification: The power distribution network is defined to include a matrix of a number of repeated leaf cells, wherein each of the matrix of repeated leaf cells corresponds to a model leaf cell wherein the model leaf cell includes an alternating Vdd and Gnd grid on top of an interposer. A plurality of local ports of the model leaf cell is defined. The plurality of local ports is defined where each of the matrix of repeated leaf cells is coupled to adjacent ones of the matrix of repeated leaf cells. The model leaf cell is simulated using an implementation of an integral equation based solver or any other computational method to compute electromagnetic scattering parameters (S-parameters) that correspond to the model leaf cell. The electromagnetic S-parameters are then cascaded across the matrix using a binary merge algorithm. S-parameters of any non-periodic power distribution network component models are represented using the S-parameters of the matrix. An overall impedance response of the power distribution network is computed based on S-parameters of the matrix and the S-parameters of any non-periodic power distribution network component models using an integrated circuit modelling program. The design is adjusted to compensate for deviations of the overall impedance response from the design specification. Once the simulated impedance response of the circuit is within the design specification, the design is finalized and the electronic circuit is produced based on the design as finalized.

In another aspect, the invention is a circuit simulation method for analyzing pre-register-transfer level phase of a power distribution network in an electronic circuit design, in which the power distribution network is defined to include a matrix of repeated leaf cells, wherein each of the matrix of repeated leaf cells corresponds to a model leaf cell wherein the model leaf cell includes an alternating Vdd and Gnd grid on top of a silicon interposer. The model leaf cell is defined to include at least one power through silicon via (TSV) to provide a Vdd power coupling to the grid. The model leaf cell is also defined to include at least one Gnd TSV to provide a Gnd coupling to the grid. A plurality of local ports is defined along peripheral edges of the model leaf cell, the plurality of local ports being defined where each of the matrix of repeated leaf cells is coupled to adjacent ones of the matrix of repeated leaf cells. The model leaf cell is simulated using an implementation of an integral equation based solver or other computational methods to compute electromagnetic scattering parameters (S-parameters) that correspond to the model leaf cell. The electromagnetic S-parameters are cascaded across the matrix using a binary merge algorithm. The binary merge algorithm includes the steps of: merging the S-parameters of two adjacent leaf cells to generate a primary higher order lateral structure; merging S-parameters of two first higher order lateral structures to generate a secondary higher order lateral structure; continuing to merge higher order lateral structures to generate successively higher order lateral structures until all of the S-parameters of each leaf cell in a row of the matrix of leaf cells are merged; merging S-parameters of each row of leaf cells into successive higher order vertical structures until the S-parameters of all leaf cells in the matrix are merged; coupling S-parameters of any non-periodic power distribution network component models to the S-parameters of the matrix; and computing an overall impedance response of the power distribution network based on S-parameters of the matrix and the S-parameters of any non-periodic power distribution network component models using an integrated circuit modelling program.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a flow chart showing a method of designing an electronic circuit by analyzing pre-register-transfer level phase of a power distribution network.

FIG. 2A is a plan view schematic diagram of a leaf cell.

FIG. 2B is a plan view schematic diagram of a matrix of leaf cells.

FIG. 2C is an elevation view schematic diagram of a leaf cell.

FIG. 3A is a schematic diagram showing a matrix of leaf cells.

FIG. 3B is a schematic diagram demonstrating horizontal binary merging of leaf cells in the matrix shown in FIG. 3A.

FIG. 3C is a schematic diagram demonstrating vertical binary merging of rows of leaf cells.

FIG. 4A is a graph showing self impedance of PDN in one experimental example.

FIG. 4B is a graph showing transfer impedance of PDN in one experimental example.

FIG. 5 is a graph showing self-impedance at the bottom of the TSVs in a leaf cell.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

U.S. patent application Ser. No. 14/816,268, filed on Jun. 3, 2015 (published as US-2016-0034633-A1) by Han et al. discloses a method of modelling circuit elements employing cylindrical modal basis functions and is therefore incorporated herein by reference.

A design team needs to determine how much power supply noise is generated between the voltage and ground rails of the transistor circuits. Circuits are non-linear and generate a current. At the early stage of the design process, the designer has an idea of the nature of the current source. For example, they know the amplitude of the current, the rise and fall times as well as the duty cycle. From this information they need to determine the details of the power distribution network such as: i) the width of the metallization on-chip, their periodicity, number of layers, details of the connectivity from the chip pads to the package, the package stack-up such as power/ground planes, details of the solder balls at the bottom of the package etc. At this point the designer needs to compute the power distribution impedance without knowing the exact structure. This impedance along with the current source can be used to determine the power supply noise.

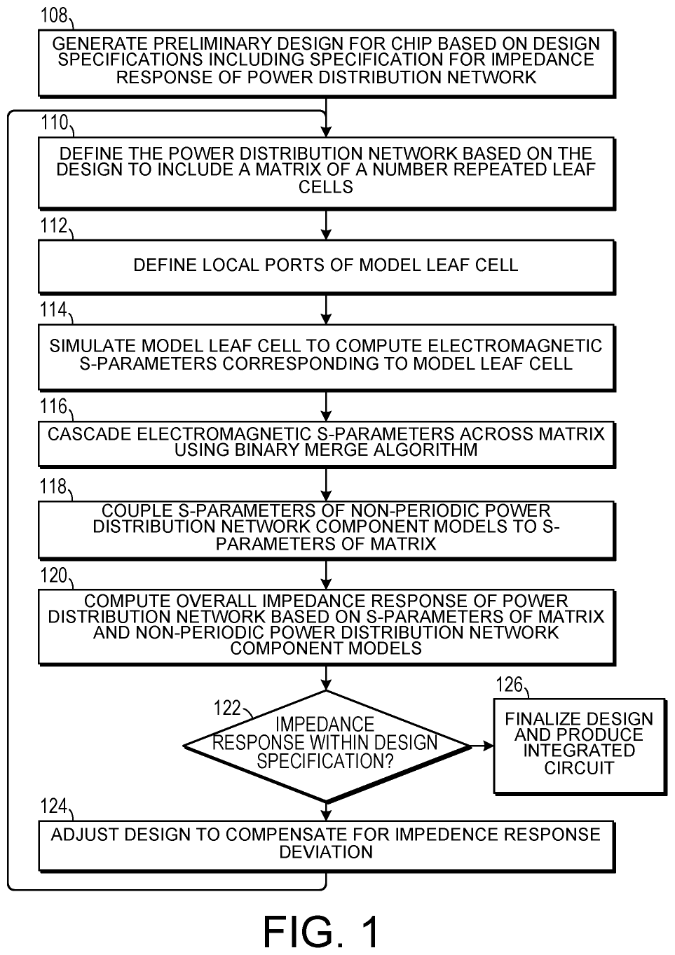

A shown in FIG. 1, several steps are generally employed in analyzing pre-register-transfer level phase of a power distribution network in an electronic circuit design. Initially, the design team starts by generating a preliminary design for a chip, or other type of circuit, based on design specifications, which include a specification for impedance response of power distribution network 108. Next the circuit is simulated using a plurality of steps that include: Defining the power distribution network to include a matrix of a number of repeated leaf cells, wherein each of the matrix of repeated leaf cells corresponds to a model leaf cell wherein the model leaf cell includes an alternating Vdd and Gnd grid on top of an interposer 110 (the interposer can include, for example, a silicon interposer, an organic interposer, a ceramic packaging interposer, or any other package); defining a plurality of local ports of the model leaf cell, the plurality of local ports being defined where each of the matrix of repeated leaf cells is coupled to adjacent ones of the matrix of repeated leaf cells 112; simulating the model leaf cell using an implementation of an integral equation based solver to compute electromagnetic scattering parameters (S-parameters) that correspond to the model leaf cell 114; cascading the electromagnetic S-parameters across the matrix using a binary merge algorithm 116; coupling S-parameters of any non-periodic power distribution network component models to the S-parameters of the matrix 118; and computing an overall impedance response of the power distribution network based on S-parameters of the matrix and the S-parameters of any non-periodic power distribution network component models using an integrated circuit modelling program 120. The design team then determines if the impedance response is within the design specification 122 and, if it is not, the design team adjusts the design to compensate for any deviations from the specified impedance response 124 and then returns to step 110 of the simulation. If the results of the simulation indicate that the impedance response meets the design specification, then the design is finalized and sent to a fabrication facility where the circuit is manufactured 126.

In this system, the periodic structure is used to an advantage to enable the design team to analyze large power distribution networks without having to make compromises on the size of the circuit since the computations are done in a different way. Therefore, the designer can continue to perform the analysis and predict power supply noise more accurately without significant increased computational burden.

The leaf cell is defined to include at least one power via which can also be a through silicon via (TSV) to provide a Vdd power coupling to the grid and at least one Gnd via or TSV to provide a Gnd coupling to the grid. The alternating Vdd and Gnd grid comprises at least one Vdd conductor and at least one Gnd conductor disposed on a first plane. The alternating Vdd and Gnd grid also includes at least one Vdd conductor and at least one Gnd conductor disposed on a second plane and a dielectric disposed between the first plane and the second plane. The model leaf cell further also includes at least one first via that couples the Vdd conductor on the first plane to the Vdd conductor on the second plane and at least one second via that couples the Gnd conductor on the first plane to the Gnd conductor on the second plane.

In the binary merge algorithm, a binary number that corresponds to the number of leaf cells in the matrix is generated. The S-parameters of two adjacent leaf cells are merged to generate a primary higher order lateral structure. The S-parameters of two first higher order lateral structures are merged to generate a secondary higher order lateral structure. Higher order lateral structures are successively merged to generate successively higher order lateral structures until all of the S-parameters of each leaf cell in a row of the matrix of leaf cells are merged. S-parameters of each row of leaf cells are merged into successive higher order vertical structures until the S-parameters of all leaf cells in the matrix are merged.

This section discusses the theoretical background of the leaf-cell based modeling of periodic array structures.

Leaf Cell and Array Concept

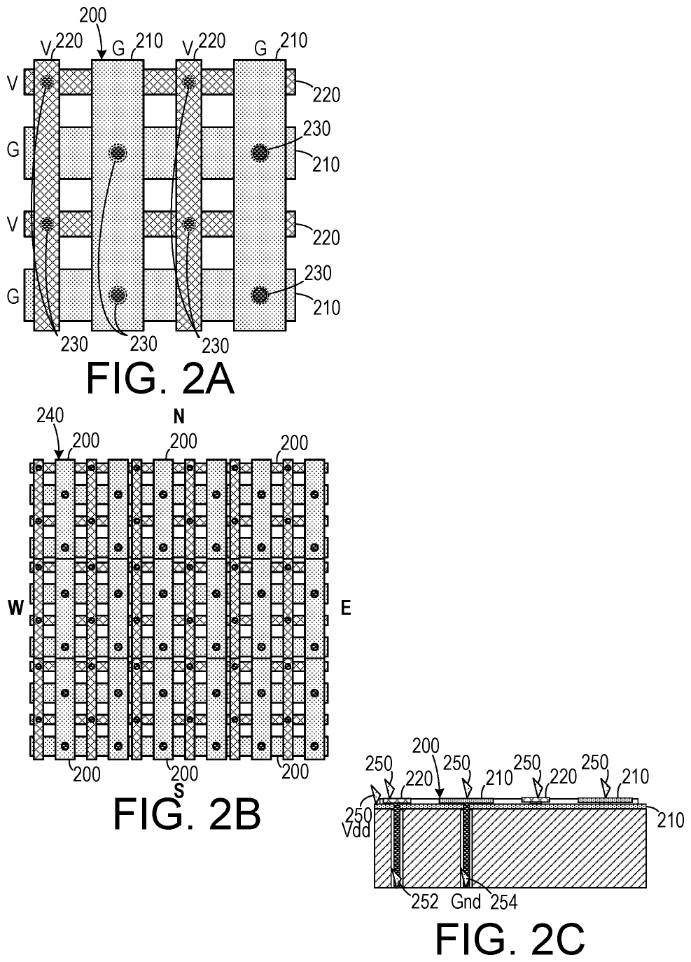

As shown in FIGS. 2A-2C, a PDN 240 array is modelled as a periodic two-dimensional structure that is composed of identical sub-circuits called leaf cells. In such large structures, each leaf cell 200 includes a grid of ground planes 210 and power planes 220, which can be interconnected with TSVs 230. The leaf cell 200 can include various package elements like plane pads, vias, balls, and wirebonds. The leaf cell model is generated by the integral equation based method that involves cylindrical modal basis functions and the conventional piecewise constant basis functions (used in the PEEC method). The leaf cell can also be modeled using any numerical electromagnetic method that includes finite element, finite difference or circuit based methods. The integral equation based method or other methods provide the multi-port network parameter (scattering parameter) model for a leaf cell, and the leaf cell can be used repeatedly to construct the entire array response 240. A plurality of local ports 250 (which can be defined along peripheral edges of the leaf cell) is defined at connection points between leaf cells. A Vdd port 252 and a ground port 254 is also defined in the model.

Node Merging:

To cascade S-parameters, a nodes merging process is applied. The node merging process includes three steps: 1) Connecting nodes of adjacent leaf cells; 2) Opening unused nodes; and 3) Assigning global user-defined ports (UDPs).

In connecting nodes of adjacent leaf cells, leaf cell nodes are merged and are conceptually classified into four directions (east, west, north, and south), and a one-to-one correspondence between nodes of east (north) and west (south) is assigned. The assigned nodes are merged by denoting them an equal voltage and forcing zero to the sum of all branch currents, including a dummy node that can be used for a user-defined port. Rearranging the original impedance matrix by nodes to be connected (VC and IC) with the others (VU and IU),

$$[ \begin{matrix}{V}_{C} \\ {V}_{U}\end{matrix} ] = [ \begin{matrix}{Z}_{CC} & {Z}_{CU} \\ {Z}_{UC} & {Z}_{UU}^{O}\end{matrix} ] [ \begin{matrix}{I}_{O} \\ {I}_{U}\end{matrix} ] \qquad ( 1 )$$

Opening Unused Nodes and Assigning User-Defined Ports (UDPs):

The nodes in (1) can be used for the UDP definitions. If not, the unused nodes (whether they are merged nodes or not) are opened by letting the branch current into the node to be zero. Finally, each UDP is defined by pairing a signal node and reference nodes, and the size of the reduced matrix follows to the number of UDPs.

$$[ \begin{matrix}{V}_{O} \\ {V}_{U}\end{matrix} ] = [ \begin{matrix}{Z}_{OO} & {Z}_{OU} \\ {Z}_{UO} & {Z}_{UU}^{O}\end{matrix} ] [ \begin{matrix}{I}_{O} \\ {I}_{U}\end{matrix} ] \qquad ( 2 )$$

where VO, IO are voltage and current vectors for connected nodes and VU, IU are voltage and current vectors for unconnected nodes. ZOO, ZOU, ZUO, ZUU are sub-matrices that are calculated from sub-matrices defined in (1) by using the following relations:

$${Z}_{OO} = \sum [ {Z}_{CO} - {{Z}_{CC}^{d} ( {Z}_{CC}^{r} )}^{- 1} {Z}_{CO}^{d} ] \\ {Z}_{OU} = \sum [ {Z}_{CU} - {{Z}_{CC}^{d} ( {Z}_{CC}^{r} )}^{- 1} {Z}_{CU}^{r} ] \\ {Z}_{UO} = \sum [ {Z}_{UO}^{O} - {{Z}_{UC}^{d} ( {Z}_{CC}^{r} )}^{- 1} {Z}_{CO}^{d} ] \\ {Z}_{UU} = \sum [ {Z}_{UU}^{O} - {{Z}_{UC}^{d} ( {Z}_{CC}^{r} )}^{- 1} {Z}_{CU}^{r} ] \qquad ( 3 )$$

Speed Up the Merging Process by Using Binary Merging:

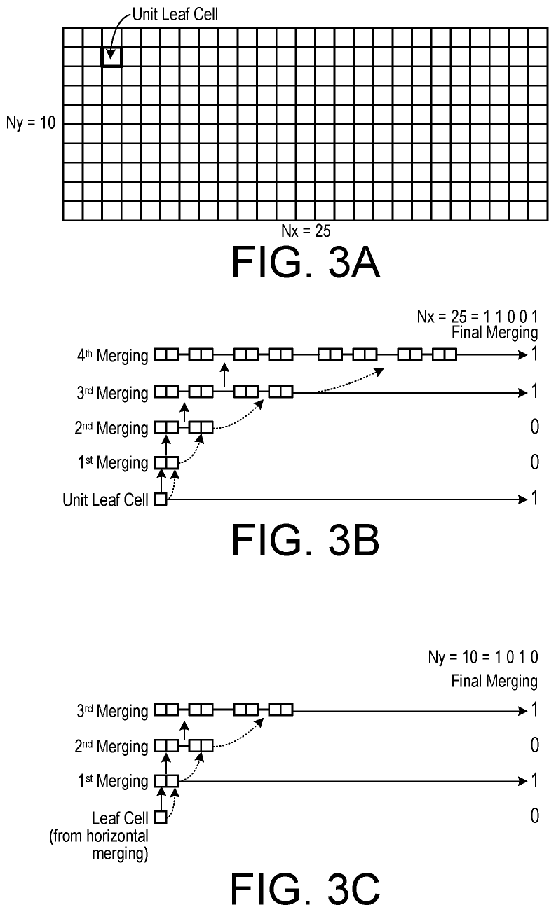

Speed up of large structure modeling without simulation of the entire domain is available by repeated use of a leaf cell. Additional speed up with memory saving is possible by skipping the repeated node connection steps. As shown in FIG. 3, the number of unit cells (Nx) along the horizontal direction can be expressed by the corresponding binary number (bnbn-1 . . . bi . . . b0). Since bit bi=1 in the binary number indicates that a sub array formed from the i-times binary merging steps is required, we can find which sub array is required to obtain the entire response. Each binary combined sub array can be generated from iterations, and it reduces the number of merging operations. The largest index number n represents the largest number of iterations of binary merging. In the final step after all the sub arrays are obtained, the sub arrays are combined at the same time. The procedure discussed above is for a horizontal array, but the same procedure can be applied for a vertical array as well. Therefore the merging process for a 2-D array can be done by consecutive binary merging processes for both horizontal and vertical directions.

Inter-Leaf-Cell Coupling:

One issue that arises is how the cascaded model can ensure the accuracy without considering the coupling between leaf cells. Generally the coupling effect between the adjacent (or sometimes fully connected) leaf cells is significant. However, in PDN structures, having their layer thickness is small and field distribution along the substrate is almost z-directional, the coupling effect is nearly localized to the boundary between leaf cells, and therefore can be neglected. The measure of accuracy can be estimated by the ratio of the effective area where the coupled fields are dominant to the area of the leaf cell. Also the ratio is dependent on the frequency and the substrate thickness. Since the leaf cell model is obtained from the integral-equation based method or other methods, each node of the leaf cell refers to the ground at infinity. Thus, we need to define a reference structure and corresponding reference nodes that are used when assigning the UDPs. Reference inclusion and correct assignment of reference nodes are important to ensure modeling accuracy after the structure has been arrayed. The technique is not limited to just PDN but to any structure where the fields are localized and propagation of the electromagnetic wave across the structure occurs due to conductive coupling (meaning the connectivity of the nodes of the leaf-cell).

One embodiment is a technique where the repeatable cell of the structure (called leaf cell) is first analyzed using an integral equation based method of moments procedure or other techniques, which has been parallelized. By establishing ports at the connection points, the unit cell is then arrayed along the lateral directions to create the full structure. The response of the overall structure is obtained by cascading S-parameters using a binary merging algorithm that provides significant savings in CPU time. The algorithm implemented and presented has no limitations on the number of ports being connected, where the response of the full structure can be obtained both at internal (inside the leaf cell) or external (outside the leaf cell).

This method provides a robust method for computing the PDN impedance at the pre-RTL phase with electromagnetic accuracy. In this method, a leaf cell of the PDN is simulated using electromagnetic (EM) analysis to determine its scattering parameters (S-parameters). The PDN is then constructed by repeating the leaf cell to form an array where the response of the PDN is computed by cascading the S-parameters of the leaf cell. Since, the PDN is often constructed using high metal density with thin dielectrics, the accuracy of this method is excellent. The advantages of this approach include the following: 1) the leaf cell can contain a multi-layered PDN which includes the chip, package and PCB. Since the leaf cell is analyzed using an EM solver, all coupling effects are included; 2) the leaf cell can be made as small or as large as necessary to include the necessary coupling effects within the leaf cell; 3) any number of local ports can be defined for the leaf cell to provide connectivity to other leaf cells; 4) since the leaf cells are connected together, a large array can be computed in a reasonable CPU time; and 5) global ports can be defined across the array where the impedances of the PDN can be computed.

The following example provides additional details on the algorithm used along with silicon interposers where the power is supplied by TSVs to a power distribution grid in the interposer.

Algorithm

The algorithm can be described in two parts, including: 1) construction of the leaf cell and its analysis; and ii) the binary merge algorithm used to cascade S-parameters across a matrix.

Construction and Modeling of the Leaf Cell:

The leaf cell structure is modeled using the integral equation based method that uses cylindrical modal basis functions for geometries with cylindrical cross section (such as vias, wirebonds, solder balls, C4s etc) and the conventional piecewise constant basis functions as used in the PEEC method for planar structures with rectangular cross section (such as redistribution lines etc). The matrix equation that is generated through discretization is then solved using a multicore processor (e.g., with 4 cores or more). The integral equation based method used provides the multi-port network parameter (S-parameter) model for a leaf cell.

In the representative example of a leaf cell of the type shown in FIGS. 2A-2C, the leaf cell consists of alternating Vdd and Gnd grid on top of a silicon interposer, as shown in FIG. 2A. The thickness of the interposer is 100 um, as shown in FIG. 2C. The Vdd and Gnd grid are on two metal layers separated by a 2 um thick silicon-dioxide dielectric. The leaf cell is of size 0.5 mm×0.5 mm, as shown in FIG. 2B. Two TSVs (one Vdd and the other Gnd) are used to provide power to each leaf cell and are positioned at the lower left corner of the unit cell. Each TSV is of diameter 10 um with an oxide liner thickness of 2 um. A standard CMOS grade interposer with conductivity of 10 S/m has been used in this example. Local ports are defined along the edge of the leaf cell (10 per side) as shown in FIG. 2B, which provide positions where the leaf cell is connected to other leaf cells during the arraying process. In FIG. 2B, orientations North (N), South (S), East (E) and West (W) are used to connect between leaf cells.

Binary Merging:

The merging algorithm is demonstrated in FIGS. 3A-3C. A matrix of leaf cells corresponding to a PDN structure is shown in FIG. 3A. Since the identical leaf cell is used repeatedly when constructing the entire PDN structure, the computational cost (time and memory) can be reduced further to connect all leaf cells by reusing the previously merged sub-cells. The method used to save merging computation time is called binary merging since it is based on the repeated merge of two sub-cells. As illustrated in FIG. 3B, the binary merging is first applied to the one-dimensional (1-D) sub-array (horizontal in the figure), and then the combined 1-D sub-array is regarded as a new unit cell for the other 1-D sub-array (vertical in the figure). The detailed process for each 1-D binary merging can be determined by encoding the number of unit cells (Nx for the horizontal array) to its corresponding binary number (bn, bn-1, . . . bi, . . . b0)2. If any bit bi=1, the entire 1-D array requires the i-times binary-merged cell. Since the most significant bit (MSB) bn is essentially one for all cases, the n-times binary merged cell is the largest sub-cell. After all the required sub-cells are ready, the conventional merging method is applied to them to generate the final 1-D sub-array model.

For each binary merge, a systematic update of node index is important to ensure that the merging is correctly processed. In the implementation presented, the following three rules of indexing a newly merged cell are defined:
1. Merged nodes in the current binary merging step are prior to the other nodes. This rule comes from the formulation of node merging, where connected nodes are indexed first by forming a sub-vector.
2. Nodes that belonged to the left (or the upper) cell are prior nodes of the right (or the lower) cell.
3. After assigning the above rules, the original node indexing defined for each elementary unit cell is applied.

After all the binary merging procedures for the horizontal and the vertical arrays are complete, the S-parameter matrix of the entire PDN model is expressed by sub-matrices between sub-vectors of connected (dummy) and unconnected nodes. Therefore the PDN model can be easily connected with other non-periodic component models.

Inter-Leaf-Cell Coupling:

One issue regarding the generation of PDN using the merging of leaf cells is how the constructed model guarantees accuracy without including the electrical coupling effect between leaf cells. Although the coupling effect between adjacent leaf cells may be significant in general, the coupling by fringing fields in PDN structures is negligible since the small layer thickness causes the field distribution to be z-directional. For such cases, the coupling effect is nearly localized within the boundary of the leaf cells. Possible error by neglecting the inter-leaf-cell coupling can be estimated by the ratio of the effective area where the coupled fields are dominant to the area of the leaf cell. In addition, the ratio depends on the frequency and the substrate thickness in terms of the wavelength. Since the leaf cell model is obtained from the integral-equation based method, each node of the leaf cell refers to the ground at infinity. To ensure that the assumption of thin substrate thickness for PDN structure is valid, a reference structure and corresponding reference nodes is defined.

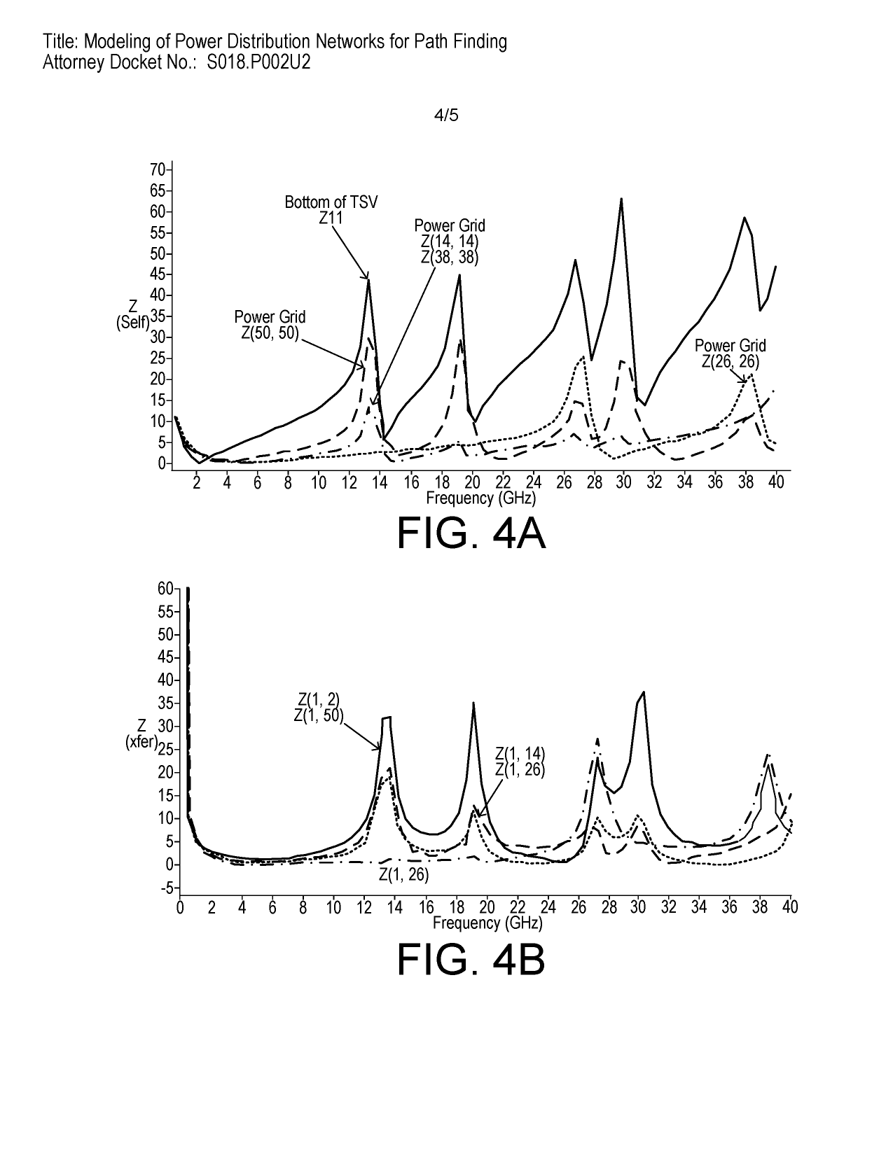

In one experimental example, a PDN is defined in a Silicon Interposer that includes a 5×5 array of the leaf cells, which corresponds to a PDN size of 2.5 mm×2.5 mm. In this model, each leaf cell contains a total of 10 ports per side which represent the local ports. During the arraying operation these ports are connected to each other, as can be seen as a grid at the interface between leaf cells. This process is done automatically using the NEWS orientation. Global ports are now defined between Vdd and Gnd. Each leaf cell has a global port at the center of the power grid (top of interposer) and a global port at the lower left (bottom of interposer). In the array, a total of 50 global ports are defined where impedances can be computed. A subset of these global ports is overlaid on the PDN. The self and transfer impedances for this model are shown in FIGS. 4A and 4B, respectively. The resonances in the PDN can be seen along with inductances and capacitances of the network.

The same leaf cell can be used to create a 10×10 array for a PDN of size 5 mm×5 mm. The position of the TSV port and power grid port can be left identical as before. This results in a total of 200 global ports for the PDN structure, a subset of which are shown in FIG. 4A. The transfer impedances between the TSV (port 1) and the ports along the diagonal on the power grid are shown in FIG. 4B.

In this experimental model, a mesh of 1×22×1 cells for Vdd and 2×22×1 cells for Gnd were used to mesh the leaf cell. The CPU time for computing the 50 port response for the 5×5 array was 633 secs for 80 frequency points on an Intel i7 CPU 870 @2.93 GHz with 4 cores and 32 GB memory. Only the leaf cell response was computed using the 4 cores. To check convergence of the results the mesh density was doubled and quadrupled along the x/y directions, but the results didn't change. The same mesh density was used for the leaf cell in the 10×10 array leading to a CPU time of 5448 secs on the same computer.

The second example considered is the same PDN above, but with 1 Vdd TSV and 4 Gnd TSVs in the leaf cell. The Vdd TSV is surrounded by Gnd TSVs where the distance between the Vdd TSV and each Gnd TSV is 70.71 um. A port was placed at the bottom of the Vdd TSV where the reference was defined at the bottom of the four Gnd TSVs tied together. Hence, the loop impedance between the Vdd and Gnd TSVs should be reduced as compared to the previous example. It is important to note that since all the TSVs are in the same leaf cell, all the coupling between the Vdd and Gnd TSVs are captured in the response during modeling.

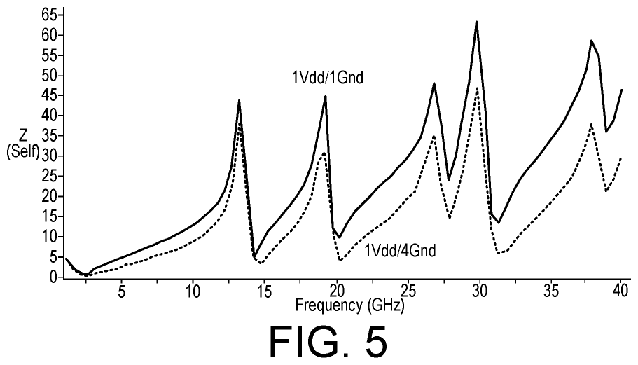

A comparison of the self-impedance for the 5×5 array using the leaf cell is shown in FIG. 5, at the bottom of the TSVs. As can be seen from the figure, the presence of the four Gnd TSVs reduces the overall self-impedance significantly, especially at high frequencies.

The present invention provides a robust method for the pre-RTL analysis of power distribution networks. The concept is based on defining a leaf cell for the PDN, analyzing the leaf cell using an efficient parallel implementation of an integral equation based solver to compute S-parameters, cascading the S-parameters using a binary merge algorithm and computing the overall response of the PDN.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of producing an electronic circuit having a power distribution network, comprising the steps of:
(a) generating a preliminary design for the electronic circuit based on a design specification;
(b) analyzing pre-register-transfer level phase of the power distribution network by repeating the following steps until simulated impedance response of the circuit is within the design specification:
(i) defining the power distribution network based on the design to include a matrix of a number repeated leaf cells, wherein each of the matrix of repeated leaf cells corresponds to a model leaf cell wherein the model leaf cell includes an alternating Vdd and Gnd grid on top of an interposer;
(ii) defining a plurality of local ports of the model leaf cell, the plurality of local ports being defined where each of the matrix of repeated leaf cells is coupled to adjacent ones of the matrix of repeated leaf cells;
(iii) simulating the model leaf cell using an implementation of an integral equation based solver to compute electromagnetic scattering parameters (S-parameters) that correspond to the model leaf cell;
(iv) cascading the electromagnetic S-parameters across the matrix using a binary merge algorithm;
(v) coupling S-parameters of any non-periodic power distribution network component models to the S-parameters of the matrix;
(vi) computing an overall impedance response of the power distribution network based on S-parameters of the matrix and the S-parameters of any non-periodic power distribution network component models using an integrated circuit modelling program; and
(vii) adjusting the design to compensate for deviations of the overall impedance response from the design specification; and
(c) finalizing the design and manufacturing the electronic circuit based on the design as finalized.

2. The method of claim 1, wherein in the adjusting step, adjustments are made to at least one of: a width of on-chip metallization in the power distribution network, metallization periodicity, number of metal layers, details of connectivity from chip pads to a circuit package, a package stack-up such as power and ground planes, and dimensions of solder balls at a circuit package bottom.

3. The method of claim 1, wherein the interposer comprises a selected one of a silicon interposer, an organic interposer and a ceramic packaging interposer.

4. The method of claim 1, wherein the local ports are defined along peripheral edges of the leaf cell.

5. The method of claim 1, further comprising the steps of:
(a) defining the leaf cell to include at least one power via or at least one through silicon via (TSV) to provide a Vdd power coupling to the grid; and
(b) defining the leaf cell to include at least one Gnd via or at least one TSV to provide a Gnd coupling to the grid.

6. The method of claim 1, wherein the binary merge algorithm includes the steps of:
(a) generating a binary number that corresponds to the number of leaf cells in the matrix;
(b) merging the S-parameters of two adjacent leaf cells to generate a primary higher order lateral structure;
(c) merging S-parameters of two first higher order lateral structures to generate a secondary higher order lateral structure;
(d) continuing to merge higher order lateral structures to generate successively higher order lateral structures until all of the S-parameters of each leaf cell in a row of the matrix of leaf cells are merged;
(e) merging S-parameters of each row of leaf cells into successive higher order vertical structures until the S-parameters of all leaf cells in the matrix are merged.

7. The method of claim 1, wherein the alternating Vdd and Gnd grid comprises at least one Vdd conductor and at least one Gnd conductor disposed on a first plane.

8. The method of claim 7, wherein the alternating Vdd and Gnd grid further comprises:
(a) at least one Vdd conductor and at least one Gnd conductor disposed on a second plane; and
(b) a dielectric disposed between the first plane and the second plane.

9. The method of claim 8, wherein the model leaf cell further comprises:
(a) a first via that couples the Vdd conductor on the first plane to the Vdd conductor on the second plane; and
(b) a second via that couples the Gnd conductor on the first plane to the Gnd conductor on the second plane.

10. A method of producing an electronic circuit having a power distribution network, comprising the steps of:
(a) generating a preliminary design for the electronic circuit based on a design specification;
(b) analyzing pre-register-transfer level phase of the power distribution network by repeating the following steps until simulated impedance response of the circuit is within the design specification:
(i) defining the power distribution network to include a matrix of repeated leaf cells, wherein each of the matrix of repeated leaf cells corresponds to a model leaf cell wherein the model leaf cell includes an alternating Vdd and Gnd grid on top of a silicon interposer;
(ii) defining the model leaf cell to include at least one power through silicon via (TSV) to provide a Vdd power coupling to the grid;
(iii) defining the model leaf cell to include at least one Gnd TSV to provide a Gnd coupling to the grid;
(iv) defining a plurality of local ports along peripheral edges of the model leaf cell, the plurality of local ports being defined where each of the matrix of repeated leaf cells is coupled to adjacent ones of the matrix of repeated leaf cells;
(v) simulating the model leaf cell using an implementation of an integral equation based solver to compute electromagnetic scattering parameters (S-parameters) that correspond to the model leaf cell;
(vi) cascading the electromagnetic S-parameters across the matrix using a binary merge algorithm, wherein the binary merge algorithm includes the steps of:
(1) merging the S-parameters of two adjacent leaf cells to generate a primary higher order lateral structure;
(2) merging S-parameters of two first higher order lateral structures to generate a secondary higher order lateral structure;
(3) continuing to merge higher order lateral structures to generate successively higher order lateral structures until all of the S-parameters of each leaf cell in a row of the matrix of leaf cells are merged; and
(4) merging S-parameters of each row of leaf cells into successive higher order vertical structures until the S-parameters of all leaf cells in the matrix are merged;
(vii) coupling S-parameters of any non-periodic power distribution network component models to the S-parameters of the matrix;
(viii) computing an overall impedance response of the power distribution network based on S-parameters of the matrix and the S-parameters of any non-periodic power distribution network component models using an integrated circuit modelling program; and
(ix) adjusting the design to compensate for deviations of the overall impedance response from the design specification wherein adjustments are made to at least one of: a width of on-chip metallization in the power distribution network, metallization periodicity, number of metal layers, details of connectivity from chip pads to a circuit package, a package stack-up such as power and ground planes, and dimensions of solder balls at a circuit package bottom; and
(c) finalizing the design and producing the electronic circuit based on the design as finalized.

11. The circuit simulation method of claim 10, further comprising the steps of:
(a) defining the leaf cell to include at least one power through silicon via (TSV) to provide a Vdd power coupling to the grid; and
(b) defining the leaf cell to include at least one Gnd TSV to provide a Gnd coupling to the grid.

12. The circuit simulation method of claim 11, wherein the alternating Vdd and Gnd grid comprises at least one Vdd conductor and at least one Gnd conductor disposed on a first plane.

13. The circuit simulation method of claim 12, wherein the alternating Vdd and Gnd grid further comprises:
(a) at least one Vdd conductor and at least one Gnd conductor disposed on a second plane; and
(b) a dielectric disposed between the first plane and the second plane.

14. The circuit simulation method of claim 13, wherein the model leaf cell further comprises:
(a) a first via that couples the Vdd conductor on the first plane to the Vdd conductor on the second plane; and
(b) a second via that couples the Gnd conductor on the first plane to the Gnd conductor on the second plane.
